(19) United States
(12) Patent Application Publication
(10) Pub. No.: US 2009/0061047 A1
(43) Pub. Date: Mar. 5, 2009

(54) HIGH-FIBER DAIRY PRODUCT

(75) Inventors: Duc NGUYEN, Fort Worth, TX (US); Noe Rizo, Fort Worth, TX (US); Jamie Shepard, Fort Worth, TX (US); Barbara Gutierrez, Fort Worth, TX (US)

Correspondence Address: OBLON, SPIVAK, MCCLELLAND MAIER & NEUSTADT, P.C., 1940 DUKE STREET, ALEXANDRIA, VA, 22314, US

(73) Assignee: THE DANNON COMPANY, INC., White Plains, NY (US)

(21) Appl. No.: 12/264,707

(22) Filed: Nov. 4, 2008

Related U.S. Application Data
(62) Division of application No. 11/104,565, filed on Apr. 13, 2005.

(51) Int. Cl. A23C 9/12

(52) U.S. Cl. 426/43; 426/34

(57) ABSTRACT

A process for producing a fermented dairy product supplemented with fiber, especially a purified digestion resistant fiber such as maltodextrin, inulin or oligofructose. This process takes advantage of the naturally acidic nature and enzymatic properties of fermented milk products such as yogurt and specific mixing and blending steps which produce a product having a superior organoleptic and textural properties. A fermented dairy product supplemented with at least 1-5% fiber, especially, a purified digestion-resistant fiber such as maltodextrin, inulin or oligofructose.

### BACKGROUND OF THE INVENTION

1. Field of the Invention

A high fiber dairy product, such as a yogurt and fruit product which is higher in fiber than conventional yogurt products.

2. Related Art

Prior to contemporary food processing methods many traditional human diets were higher in fiber than those of the modern industrialized world. Modern diets are often characterized as being high in saturated fat, sodium, processed carbohydrates and sugars, but low in complex carbohydrates, certain vitamins and nutrients and fiber.

Some anthropologists and nutritionists have suggested that the reference standard for the modern human diet should be based on the diets of hunter-gatherers that existed prior to modern agriculture about 20,000 years ago, because the human digestive system has not had enough time to genetically adapt to new foods, such processed low-fiber foods in modern diets. Evidence suggests that the ancestral human diet was higher in fiber, protein, polyunsaturated fats, vitamins, minerals and antioxidants, and lower in carbohydrate than the modern diet, Mann, J., Asia Pacific J. Clin. Nutr. 13(suppl): S17, 2004); O'Keefe et al., Mayo Clin. Proc. 79(1):101-8, 2004).

Whether or not the human digestive system is specifically adapted to a high fiber diet, higher fiber diets have been shown to provide many benefits. These benefits include increasing stool bulk and laxation and mineral absorption, and reducing the incidence or severity of so-called modern degenerative diseases (Weisburger, Eur. J. Cancer Prev. 11 (Suppl 2:S1-7, 2002). Fiber traps cholesterol and bile acids in the gastrointestinal tract reducing their absorption and can slow absorption of sugars, thus modulating blood sugar levels. High fiber diets improve intestinal ecology (James et al., Intern. Med. J 33(7):291-6, 2003) and help avoid or treat diverticulitis (Mayo Clin. Womens Healthsource 4(11):6, 2000), and reduce the risk of cancer (CA Cancer J. Clin. 53(4):201-2, 2003), hypertension and heart disease (Wu et al., Am. J. Clin. Nutr. 78(6):1085-91, 2003, “Dietary fiber and progression of atherosclerosis: the Los Angeles Artherosclerosis study” and diabetes (Brand-Miller, Nutr. Rev. 61(5 Pt 2):S49-55, 2003, “Glycemic load and chronic disease”; Mayo Clin. Health Lett. 20: 4, July, 2004, “High-fiber diet may lower diabetes risk”). A diet high in fiber also is useful for weight loss as bulky fiber provides a feeling of satiety (Howarth et al., Nutr. Rev. 59(5):129-39, 2001 “Dietary Fiber and weight regulation”).

Many processed foods have had a substantial amount of fiber removed from them. To name a few, baked goods such as white bread, cakes, pies, potato chips and other snacks, high sugar foods such as candy and soft drinks usually have very low fiber content. Protein-rich diets may be very low in fiber since many protein-rich foods, such as eggs, meat, fish and dairy products have little or no fiber. Moreover, many people avoid, dislike or find inconvenient eating unprocessed fruits and vegetables which have a high fiber content. Diets rich in processed foods and low in unprocessed fruits and vegetables reduce the overall fiber intake.

The American Dietetic Society recommends a daily fiber intake of between 20 and 35 grams and the Food and Drug Administration (“FDA”) sets a daily value (“DV”) of 25 grams of fiber per day based on a 2,000 calorie diet. However, most Americans only consume about 17 grams of fiber a day. Modern processed foods have eliminated fiber for ease of processing, handling, preparation and storage of these products, and also to produce foods having desirable textures, flavors and colors that appeal to purchasers and consumers of these products. To obtain the benefits associated with a high fiber diet, ideally a food readily acceptable by consumers and easy to process, handle and store would also contain a significant amount of fiber.

Mammals naturally consume and metabolize milk products and milk products have been part of the human diet for thousands of years. Fermented dairy products have been consumed for thousands of years and probably date back to a period when humans made the transition from food gatherers to food producers. Moreover, the human digestive system has adapted to metabolizing milk, for example, by acquiring the ability to metabolize lactose. Dairy products provide significant amounts of protein, vitamins, potassium, calcium and other nutrients as well as probiotic bacteria, however, they contain insignificant amounts of fiber.

Fiber has been proposed as a possible ingredient for dairy products. U.S. Pat. No. 4,797,289 describes the introduction of apple, pear, and vegetable fiber into yogurt to promote the growth of Lactobacillus acidophilus. U.S. Pat. No. 4,971,810 describes a method for making fiber-rich yogurt by adding soy fiber, oat fiber and gum arabic (Acacia tree gum) to a base mixture containing milk. However, the use of complex mixtures of natural fibers can make it difficult to standardize and process a product and negatively impact a product's consumer appeal and acceptance.

Consumers associate fermented dairy products such as yogurt with a smooth and creamy texture, as well other organoleptic properties, such as a certain mouthfeel and taste. Supplementing a product such as yogurt with fiber while maintaining desirable texture and flavor as discussed below presents new problems. Similarly, adding a fiber component requires adaptation of existing processes, such as a conventional yogurt production processes, so as to provide a uniform or standardized product while minimizing or simplifying process steps and reducing costs.

Supplementation of fermented dairy products with natural fibers can be a challenge since the incorporation of fiber may detract from these desirable characteristics. For instance, complex mixtures of natural fibers may contain undesirable components, such as allergens, and may contain variable amounts of components that complicate standard formulation of a fermented dairy product. The complexity and non-uniformity of many fiber or fiber-like ingredients makes it difficult to identify all the components in the final product and can result in a product with variations in taste, texture and appearance. For example, gum arabic is a complex and variable mixture of arabinogalactan oligosaccharides, polysaccharides and glycoproteins and some components of gum arabic are known allergens, Bertling von, L. Versteckte Nahrungsmittel-Allergene (Hidden food allergens), Allergologie; 9: 413-415, 1986. While soy fiber has been proposed as a fiber additive, there are at least 15 different allergens which have been identified in soy products. Some people, especially infants, are allergic to soy, Bardare M et al., “Soy sensitivity: personal observation on 71 children with food intolerance” Allerg. Immunol. Paris 20(2):63-6, 1988. Thus, significant obstacles must be overcome to design a high fiber fermented dairy product having acceptable nutritional and organoleptic properties, which is also easy to produce and standardize.

Yogurt making processes and processes for making other types of fermented dairy products are known, however, the incorporation of fiber into these products can present new problems. If fiber is added during fermentation it can alter the fermentation conditions and affect the organoleptic characteristics of the final product. Yogurt is produced by fermenting milk with a combination of Streptococcus thermophilus and Lactobacillus bulgaricus and generally has about a 1:1 ratio of streptococci to lactobacilli. The Streptococcus produces lactic acid lowering the pH of the yogurt product and causing thickening of the milk proteins. Lactobacillus produces many of the important flavoring components contained in yogurt such as acetaldehyde (ethanal), acetic acid, volatile fatty acids, ethanol, carbon dioxide and other flavoring components such as diacetyl. Diacetyl contributes to the characteristic yogurt flavor and can impart smoothness and even a buttery flavor to a yogurt. Similarly, acetaldehyde is a volatile flavoring component important for yogurt aroma. These flavor components require a proper concentration and balance to produce an organoleptically acceptable yogurt flavor and aroma. However, the addition of fiber to a yogurt product during fermentation can have unpredictable effects on flavor and aroma, as well as texture and stability of a fermented dairy product. Variations in pH caused by over- or undergrowth of bacteria affect protein agglomeration, texture and taste of a product. Syneresis or separation of liquid and solid components of a yogurt may occur. These properties are undesirable from the perspective of consumer appeal and reduce the effective shelf life of a product, since consumers view a separated yogurt or yogurt-like product as being old, unappealing or unappetizing. For example, if a fiber preferentially enhances the growth of streptococci, a harsh, sour yogurt can be produced due to reduction of the flavoring components provided by lactobacilli, but if the fiber enhances the proportion of lactobacillus protein agglomeration and texture of the final product can be adversely affected. The present inventors have found that certain types of fiber, such as digestion-resistant maltodextrin, do not adversely affect the organoleptic characteristics of fermented dairy products, even when added prior to or during fermentation of the milk products.

### BRIEF SUMMARY OF THE INVENTION

The present inventors have discovered a method for producing a high fiber fermented dairy product, such as a high, low, or non-fat yogurt, having a superior taste, mouthfeel, texture, stability and other organoleptic properties. These fermented diary products have significantly higher fiber content than conventional yogurt or yogurt-like products and may be incorporated into a higher fiber diet or regimen. Moreover, these products are easy and economical to produce, store and transport.

Some aspects of the invention include, but are not limited to, the following:

A high fiber fermented dairy product containing soluble fiber, insoluble fiber or a combination of both soluble and insoluble fibers. Such a product may contain about 1-5% of one or more purified soluble fibers, such as digestion-resistant maltodextrin, inulin or oligofructose, which blend into the final product and are visually unapparent or invisible. It may also contain a visible fiber component such as a cereal bran or germ, or a mixture of both visible and invisible fiber components. Visible fiber may be added to enhance the appearance or change the texture of a product or may be an indicator of the total fiber content of the product. Conveniently, such a product may incorporate fruit or fruit juices, have a viscosity ranging from 500 to 2,000 mPa·s, a pH ranging from 4.0. To 4.7, and have a smooth, firm texture and mouthfeel and an appealing appearance, color and taste.

A high fiber fermented dairy product that is low in carbohydrate, or which has a reduced glycemic load compared to a conventional dairy product and which can reduce the carbohydrate load of the fermented product by at least 10-25%, 25%-50%, or 50-75% or more.

A high fiber fermented dairy product which is classified as full fat (at least 3.5% fat), low fat (less than 2.0% fat), or fat-free (less than 0.5% fat). Such a high fiber product may also be “reduced fat” and contain less fat than a product conventionally classified as full fat but more fat than one classified as low fat, e.g., a product containing from 2.0-3.5% fat.

A high fiber fermented dairy product which contains fats or oils, such as omega-3 oils or conjugated linoleic acid, particular natural or beneficial ratios of fat or oil components, or fat-soluble vitamins, such as vitamins A, D, E or K.

A high fiber fermented dairy product that also provides pre-, pro-, or synbiotic benefits. For example, a fermented dairy and fruit product having significant amounts (e.g., ≧10⁶ CFU/gr, >10⁸ CFU/gr or >10¹⁰ CFU/gr) of live and active Lactobacillus bulgaricus and Streptococcus bulgaricus bacteria, or optionally, other live and active probiotic bacteria, such as Lactobacillus acidolphilus or Lactobacillus casei. Such a product can help restore the balance of intestinal flora and enhance specific or nonspecific immunity when consumed.

Another aspect of the invention is a simple and economic process for producing a uniform and standardized high fiber fermented dairy product. The process may employ the separate fermentation of a milk product and mixing of the fermented milk product with a fruit preparation containing one or more fiber components and other additives, such as sweeteners, vitamins, acidulants, vitamins or minerals, etc. Alternatively, if the fiber component is not added as part of a fruit preparation, it may be added to the dairy ingredients prior to or during fermentation, or separately (from the fruit preparation) to the fermented milk product (or a mixed fruit and fermented milk product) after fermentation. Inline static mixing or dynamic mixing may be used to produce the final product.

### DETAILED DESCRIPTION OF THE INVENTION

“Fermented dairy products” include those produced by the fermentation of cream, whole, skim or partially skim milk, low-carbohydrate (e.g., ultrafiltered or lactose-reduced) milk, reconstituted dry milk, milk concentrates, MPC (milk protein concentrate), WPC (whey protein concentrate), milk solids, dry milk, whey, albumin, casein or caseinates, or mixtures of any of these ingredients. These products include yogurt, yogurt and fruit mixtures, such as swiss-style yogurt, Eastern or Western sundae-style yogurt, yogurt-like products, dairy-based drinks, including those containing yogurt or a yogurt-like product. This term includes yogurt and yogurt-like products (such as smoothies which contain yogurt or yogurt and fruit) which are fermented at least with Streptococcus thermophilus and Lactobacillus bulgaricus. It also includes other fermented dairy products such as acidophilus milk, kefir, koumiss, cultured cream, sour cream, baker's cheese, cottage cheese, cream cheese, other soft or hard cheeses, quarg, buttermilk, including reduced or non-fat types of these products produced using other types of fermentative microorganisms. The microorganisms used to make these products are well-known in the dairy arts, for example, Lactobacillus acidophilus is used in acidophilus milk; buttermilk may be fermented with Streptococcus lactis, S. cremoris, Leuconostoc citrovorum and/or L. dextranicum. Streptococcus cremoris may be used to ferment unripened soft cheeses and various cheese products, and mixtures of microorganisms including yeasts are employed in the production of koumiss and kefir.

The terms “higher fiber” or “high fiber” refer to products containing more fiber than a similar conventional fermented dairy product. An example of a higher fiber fermented dairy product would be yogurt supplemented with a fiber component such as digestion-resistant maltodextrin. Conventional dairy products contain little or no fiber. Any amount of supplementation, for example, 0.1% to 50% fiber addition would produce a higher fiber dairy product. However, too low an amount of fiber will not provide the benefits associated with fiber consumption and too high an amount can complicate the processing of a fermented milk product or yield a product with commercially undesirable properties. Conveniently, a high fiber yogurt or yogurt-like dairy product will contain about 1-5% fiber (2.26-11.3 gr per 8 oz serving) or enough fiber to provide at least 2.0-3.5 grams of fiber per 4 oz. serving. The U.S. FDA sets a DV (daily value) of 25 grams of fiber per day based on a 2,000 calorie diet and 30 grams of fiber per day based on a 2,500 calorie diet. Based on these values a serving of yogurt containing at least 10% of the DV for fiber would be a good source of fiber and a serving supplying at least 20% of the DV for fiber could be considered a high source of fiber.

Most of the fiber content of a fermented dairy product will be invisible, or blended into the product. For example, as when digestion-resistant maltodextrin is blended into the yogurt or fruit components. However, a visible fiber component, such as wheat, oat, rice bran or germ or flax seed, may be added to improve product appeal. The visible fiber component is generally less than 1.0% of the final product, for example, 0.005, 0.05, 0.1, 0.2, 0.4, 0.5, 0.6, 0.7, 0.8, 0.9%. However, more visually apparent fiber may be added depending on the desired appearance and organoleptic properties of the final product, for example, 1, 2, 3, 4 or 5% of the total fiber in the fermented milk product may be visually apparent. Visible fiber components may include various cereal brans or germs, including wheat bran, wheat germ, and/or oat, rice or barley germs or brans or whole or ground seeds, such as flax seed or flax seed meal. Flax seed is also a source of omega-3 oils.

Fiber that is visible in the fermented milk product may be added as a visible indication of the total fiber content or as an indicator of product type. A predetermined amount of visible fiber based on total fiber content may be incorporated into the product. For example, 0.01, 0.05, 0.1, 0.25, 0.5, 1, 2, 3, 4, 5, 6, 7, 8, 9 or 10% (or any intermediate value) of the total fiber content of the fermented dairy product may be visually apparent. This provides the consumer with a readily visible guide for evaluating the fiber content of the dairy food and can positively contribute to the perceived organoleptic and health-promoting properties of the product.

Fiber components which may be incorporated into the fermented dairy product include digestion-resistant maltodextrin (e.g., Fibersol-2™ soluble fiber), fructooligosaccharide (FOS, oligofructose), gum, inulin, pectin, polydextrose, cellulose or hemicellulose, lignin or digestion-resistant starches. The technical data describing Fibersol 2 is incorporated by reference to the Masutani America, Inc. Fibersol 2 Printable Tech Data (Dec. 30, 2004, www.matsutaniamerica.com). Fibersol 2 is prepared by hydrolysis of the starch fraction of corn, is water soluble up to 70% (w/w) at 20° C., has a viscosity of about 15 cps for a 30% solution, has water soluble dietary fiber of 90% minimum DSB in accordance with AOAC method #2001.03) and has a carbohydrate profile of about DP1 (1.5%), DP2 (2.5%), DP3 (4.0%), DP4-6 (12.0%) and DP7+ (80%). The fiber component(s) of the present invention are not limited to Fibersol 2. Preferably these components are used in purified form so as to exclude unknown ingredients or potential allergens and help standardize product handling and composition from batch-to-batch.

Other purified fiber components, such as oligofructose or fructooligosaccharides (FOS), or inulin may be added. Preferably, these fibers are at least 90, 95, 99, or 100% pure. Addition of FOS provides a clean, somewhat sweet flavor, enhances mouthfeel of low fat products, acts a humectant, and provides prebiotic benefits by promoting fermentation by beneficial gut bacteria. An example of FOS is Nutraflora™ a 95% pure, short-chain FOS. Inulin is another soluble fiber which has a very low glycemic index making it useful for products consumed by diabetics and others on a low-carbohydrate or sugar diet, as well as reducing cholesterol levels. It also exerts prebiotic effects and may increase the absorption of minerals such as calcium from the digestive system. Inulin also acts as a bulking agent, texturizer and fat-replacer.

The type and amount of fiber to be incorporated into the fermented dairy product may also be selected to reduce the net carbohydrate content or reduce glycemic load of the product. Fermented dairy products having reduced net carbohydrates may also contain glycerol, alcohol, sugar alcohols, or sweeteners containing modified saccharides or sugars which do not substantially add to their net metabolizable carbohydrate content. Net carbohydrate content may be calculated by subtracting nondigestable carbohydrates, such as fiber or sugar alcohols, from the overall carbohydrate content.

Generally bovine milk products are used to produce a fermented milk product, such as yogurt, however, the fermented milk product may also be produced from the milk of other mammals, such as goats or sheep. Substitute milk products, such as soy, coconut, rice, or nut milks (e.g., almond or cashew milks) can also be added to or substituted for the animal milk mixtures to produce yogurt-like products. Fermented vegetable milk products or blends of animal and vegetable milks, may also be supplemented with fiber as described herein.

Conventional yogurts include non-fat yogurt (fat not to exceed 0.5%), low-fat yogurt (fat content ranging from 0.5%-2.0%, and yogurt (fat content not less than 3.25%). Yogurts produced from non-fat, low-fat, whole milk or mixtures of milk and cream may be produced. Lactose-reduced, lactose-free or ultrafiltered milk may also be employed to reduce the lactose or carbohydrate content of a fermented milk product. If desired, lactase may be added to the fermentation ingredients or products to further reduce lactose content. Yogurts may be produced as set or blended yogurts.

Fermented dairy products, such as yogurt, may be prepared by hydrating a mixture containing milk, dry milk, or other milk solids. After suitable hydration of the milk mixture occurs, usually after a period ranging from about 30 minutes to 2 hrs, the milk mixture is preheated and homogenized. The resulting mixture is then pasteurized, for example, at a temperature of about 198° F. for approximately 6 to 7 minutes. Pasteurization may be performed in-line using HTST (high temperature short time) procedures. The pasteurized milk mixture is then cooled to a temperature suitable for fermentation by lactose metabolizing bacteria.

The cooled milk mixture is inoculated with appropriate strains of bacteria, such as Lactobacillus bulgaricus and Streptococcus thermophilus. Optionally, a fiber component such as digestion-resistant maltodextrin may be added at this time. This is desirable if partial digestion of the fiber component by the fermenting bacteria is desired or to improve the association of live fermenting bacteria with the fiber component. Other strains of lactose-fermenting bacteria may also be added, such as Lactobacillus acidophilus or Lactobacillus bifidus, to assist in the fermentation or provide probiotic properties to the final product.

To augment the probiotic properties of the higher fiber yogurt-like product Lactobacillus casei may be added, for example in an amount of ≧10⁵, 10⁶, 10⁷, 10⁸, 10⁹, or 10¹⁰ CFU/ml. Other probiotic microorganisms which may be added in similar amounts either during or after fermentation include Lactobacillus gasseri, Lactobacillus plantarum, Lactobacillus johnsonii, Lactobacillus reuteri, Lactobacillus rhamnosus, Bifidobacterium bifidum, Bifidobacterium lactis, Bifidobacterium longum, Bifidobacterium breve, Bifidobacterium infantis, Enterococcus faecium, Enterococcus faecalis, and Streptococcus salivarius or the yeast Saccharomyces boulardii. Probiotic strains are also described by Fermented Foods and Healthy Digestive Functions, Danone Vitapole Research (2001) or The Intestinal Microflora, Danone Vitapole (2003) which are hereby incorporated by reference.

The inoculated milk culture is maintained under conditions favoring curd formation and thus allowed to ferment without substantial agitation. Generally, the fermentation temperature is kept within the range of 102±2° F. When the mixture reaches a pH ranging from about 4.4 to 4.6, usually, about 4.6, it is agitated and cooled to slow or stop the initial fermentation.

The resulting yogurt-like base product (white mass) is then held a temperature of about 50-68 degrees F., and filtered to remove lumps, for instance, by passage through a ⅛ inch wire mesh filter. The yogurt-like base product (white mass), may then be stored at a reduced temperature for 10-15 hours, e.g., at 50-68° F., until mixing with the fruit preparation.

The fruit preparation may be a conventional fruit purees or sauce, or chopped fruit pieces. For ease of consumption fruit pieces are generally no larger than 6 mm in diameter in the final product. Generally, it is convenient to add the fiber component to the fruit preparation to simply and standardize the process. For example, it is easy to standardize the fiber content of preparations produced from different fruits by adding and adjusting the amount of digestion-resistant maltodextrin in the fruit preparation. However, the fiber component may be added to the ingredients used to produce the white mass before fermentation, after fermentation to the white mass, or to a fruit preparation that is mixed with the white mass.

The typical fruit base is 30-50% fruit with a maximum piece size of ⅛″ to avoid a choking hazard; 30-50% water, 20-25% sugar, such as fructose or sucrose, 0-10% fruit juice (single strength), and 1-5% of a suitable stabilizer, and color (e.g. vegetable or fruit juice concentrate, such as beet or carrot juice concentrate, annatto extract or carmine, or other natural or artificial color), flavor, acid (e.g., citric or malic acid), buffer (e.g., sodium citrate) and/or preservative (e.g., potassium sorbate).

A fruit preparation containing natural sugars or added sweeteners may be used. To keep sugar content of a product low no sugar need be added to a fruit preparation or a non-nutritive sweetener may be employed. Sugar content in such fruit preparations may range from 0% to about 50% and the corresponding carbohydrate content of such fruit preparations may range from 2-30%, for example, from 5-8%. These sugar and carbohydrate content values include all intermediate values and subranges. Fruit or vegetable juice may be added as a concentrate or at single strength and from a single type of fruit or from multiple types of fruit. Such juices include, but are not limited to juices from fruit preparations conventionally found in yogurt products, such as berry juices, strawberries, peaches, or tropical fruits, as well as grape juice, white grape juice, apple juice, pear juice, apricot juice, pineapple juice, pomegranate juice, and passion fruit juice.

The exact amounts of fruit solid contents may be selected based on the particular type of fruit, keeping in mind the characteristics of the final product. Exemplary ranges for fruit solid content in the fruit preparation are 2 to 60%; exemplary pH values range from 3.6 to 4.4; and exemplary BRIX and BOSTWICK values range from 5 to 50 and 5 and 12, respectively. For example, the BRIX of the fruit preparation may be about 35. The density of the fruit solid content may range from about 8.0 to 10.0 lbs/gal, preferably from 8.2 to 8.8 lbs/gal. These values include all intermediate values and subranges. For example, a fruit preparation may have acidity of about pH 3.9 a BRIX of about 31 and a BOSTWICK at 40° F./60 sec of about 9 cm. Its density may be about 9.5 lbs/gal. The amount of fruit preparation is also selected to provide suitable organoleptic properties to the yogurt-like product. Exemplary ranges are from 3-25% by mass, including all intermediate values and subranges, such as 5-20%, 10-15%, and 15-20%. Exemplary values include 3, 4, 5, 6, 7, 8, 9, 10, 11, 12, 13, 14, 15, 16, 17, 18, 19, 20, 21, 22, 23, 24 and 25%. The fiber content in the fruit preparation is adjusted so that when the fruit preparation is mixed with the other ingredients, e.g., with white mass in a ratio of 90:10, that the fiber content of a 4 oz serving of the fermented dairy and fruit product contains about 2.0-3.5 grams of fiber.

Examples of suitable fruit solids and other flavors include apple, apricot, banana, blueberry, blueberries and cream, boysenberry, caramel, cheesecake, cherimoya, cherry, cherry-vanilla, chocolate, coconut, coffee, coffee-cappuccino, cranberry, custard, crème-brulee, guava, lemon, key lime, mango, margarita, mixed berries, orange, papaya, passionfruit, peach, peaches and cream, pineapple, pina-colada, pistachio, plum, pina colada, pomegranate, raspberry, raspberries and cream, raspberry-cranberry, raspberry-peach, spice, strawberry, strawberry-banana, strawberries and cream, strawberry-kiwi, tangerine, toffee, tropical, vanilla and vanilla cream.

The process of the invention may further comprise mixing conventional food additives into the dairy based product before or during inline mixing of the fruit and yogurt-like product components. Additives, such as acidulants, antioxidants, bulking agents, bulking sweeteners, colorants, dietary fiber, emulsifiers, enzymes, fat replacers, flavors, flavor enhancers, gases, preservatives, non-nutritive sweeteners, processing aids, stabilizers or thickeners which may be added to consumable foods and beverages are known in the art and are described by the Kirk-Othmer Encyclopedia of Chemical Technology, 4th edition, vol. 11, “Food Additives”, pages 805-833, which is incorporated by reference. For example, modified food corn starch, artificial and natural flavors, sodium citrate, malic acid, potassium sorbate, or annatto extract, caramel color, Red 40 or Blue 1 may be added.

Sweeteners may be added to the fermentation ingredients or to a fermented dairy product, such as yogurt, directly. They may also be added to a fruit preparation prior to its mixture with the diary product or may be added during mixture of the diary product and the fruit preparation.

Natural sweeteners include sucrose, dextrose, fructose, high-fructose corn syrup, or tagatose (which naturally occurs in some dairy products, and which has anti-hyperglycemic, prebiotic and anticariogenic properties). Fructose is a natural sugar found in many fruits and has a low glycemic index compared to glucose. Thus, while selection of a sugar such as fructose increases carbohydrate content, it reduces the glycemic load on an individual compared to use of higher glycemic sugars.

Sucralose is a low-calorie sweetener made from sucrose. It is about 600-times sweeter than sucrose and does not contain calories. Sucralose is stable under a wide range of different processing conditions and can be effectively used as a substitute for sucrose. Sucralose is made from sucrose and has no effects on blood glucose or serum insulin levels.

Other sweeteners include but are not limited to acetsufame K, alitame, aspartame, cyclamate, erythritol glycyrrhizin, neohesperidin dihydrochalcone, neotame, saccharin, stevioside, or thaumatin. Sweeteners and nonnutritive sweeteners as well as their chemical and organoleptic properties, stability, and degrees of sweetness are described by the Kirk-Othmer Encyclopedia of Chemical Technology, 4^{th} edition, vol. 23, “Sweeteners”, pages 556-582, which is hereby incorporated by reference. Sweetness inducers, enhancers and inhibitors may also be added to the yogurt-like product or used to adjust its organoleptic properties. These are also described by the Kirk-Othmer Encyclopedia of Chemical Technology, 4^{th} edition, pages 575-577, and are incorporated by reference.

The type and amount of sweetener may be selected to minimize the glycemic load of a low-carbohydrate yogurt-like product. For example, a sweetener with a low glycemic index or a having a high degree of sweetness may be selected. The yogurt-like product of the present invention can have a glycemic index of below 10, below 15, below 20, below 30, below 40, below 50 or below 60. Preferably the glycemic index of the product is kept low, however, a higher glycemic index may be counterbalanced by reducing the glycemic load of the yogurt-like product by keeping the net carbohydrate content low or by addition of one or more fiber(s) than slows the digestion and release of carbohydrates and sugars in the product. The carbohydrate content of the fermented milk product may be adjusted to be less than 4.9%, preferably less than 4, 3, 2 or 1%, by producing the fermented product with low carbohydrate milk products and/or by the selection of low glycemic sweeteners.

In a preferred process, the fermented dairy base product and fruit preparation containing the fiber component are separately introduced and mixed by means of an inline mixer. Dynamic or static mixing may be used to mix the primary components. However, dynamic mixing is convenient for mixing denser components containing fiber. Suitable dynamic and static mixers are known in the art and any type of mixer may be used so long as it results in the production of a homogeneous product with the desired viscosity and organoleptic characteristics. One may select a suitable mixer from amongst those known in the art, for example, from those described by the Kirk-Othmer Encyclopedia of Chemical Technology, 4th edition, “Mixing and Blending”, vol. 16, pages 844-887, or by pages 201-204 of Yogurt Science and Technology, both of which are hereby incorporated by reference.

The massic ratio of fermented dairy base product or white mass:fruit preparation introduced into the inline static mixer ranges from 100-75: 0-25%. Depending on the characteristics of the yogurt-like product and the fruit preparation and any food additives, an appropriate ratio is selected to provide a final high fiber diary product having a pH in the range of 4.0 to 4.5 and a viscosity in the range of 500 to 2,000 mPa·s. Viscosity may be determined using a Mettler RM180 Rheomat rotational viscometer.

After mixing is completed the high-fiber fruit-based and dairy-based product has a pH in the range of 3.4 to 4.6. Above a pH of 4.6, the mixture is less resistant to the growth of undesirable microorganisms. Other suitable pH ranges include pH 4.05 to 4.45, pH 4.1-4.4, and pH 4.2-4.3. However, any subrange or intermediate value in the above pH ranges is contemplated. Exemplary pH values are 3.4, 3.5, 3.6, 3.8, 4.0, 4.05, 4.1, 4.25, 4.35, 4.45, 4.5 or 4.6.

The high fiber dairy product, such as yogurt and fruit, made by the process of the invention has viscosity in the range of 500 to 2,000 mPa·s. Other suitable viscosity ranges include 1,000 to 1,400 mPa·s, and 1,100-1,300 mPa·s. Exemplary viscosities are 500, 600, 800, 900, 1,000, 1,050, 1,100, 1,200, 1,250, 1,300 and 1,400 and include any intermediate value or subrange of the ranges indicated above.

The resulting higher fiber dairy product may then be filled into containers and the containers palleted for distribution. The palletized product is shipped under refrigerated conditions.

Other fiber components, instead of or in addition to digestion-resistant maltodextrin, may be used to increase the fiber content of a fermented dairy product. Addition of fiber can further reduce the glycemic index of the yogurt product, enhance its texture, improve its digestibility, or provide pro- or prebiotic properties to the yogurt-like product. The amount of fiber to be added may be determined based on the effects of the added fiber on organoleptic and glycemic properties of the fermented milk products. The fiber content may range from about 1-5%. For example, a product which provides a good source of fiber may have at least 2% added fiber or at least 2.5 g per serving. Both insoluble and soluble dietary fiber is not digestible by intestinal enzymes. Insoluble dietary fiber is not soluble in boiling water, whereas soluble fiber is.

Soluble fiber is a component of many fruits and vegetables and includes pectins, gums and mucilages. For example, soluble fiber appears in oat products, legumes, including beans, barley, citrus and other fruits, psyllium and gums, such as pectin, guar gum (galactomannan polymer) and gum arabic (Acacia gum) and konjac gum (glucomannan).

Insoluble fiber is a component of the outer coverings (bran) of grains such as corn, oats, rice and wheat or obtained as a component of fruits and vegetables. Grain germs, such as oat, rice or wheat germs are also good sources of insoluble fiber. Fax seed or ground flax seed are also good sources of fiber. Insoluble fiber decreases intestinal transit time slows the hydrolysis of starches and can delay the absorbtion of sugars. Other useful fibers include oat fiber or oat bran (contain both soluble and insoluble fiber), and the prebiotic compounds inulin, oligofructose, and maltodextrin.

A fiber ingredient may be selected for its ability to stabilize or improve the gellation or emulsification of the low-carbohydrate fermented dairy product.

To minimize carbohydrate content or reduce the glycemic index a fiber having no or very low net carbohydrate is selected. For example, inulins or oligofructoses can provide a mild sweet taste and a full feeling like starchy foods, but are not absorbed and do not significantly affect blood sugar. Such compounds also have prebiotic activity and can enhance the growth of probiotic bacteria when ingested. For example, inulin can facilitate the growth of intestinal bifidobacteria. Compounds like inulins can also provide a creamy or smooth texture and even a fatlike mouthfeel without adding to the net carbohydrate content of a fermented milk product. Carbohydrate content of the fermented product may also be controlled by selecting ingredients having a low carbohydrate content. For example, reduced lactose milk or ultrafiltered, diafiltered or nanofiltered milk products may be selected for fermentation to control carbohydrate content.

Higher fat products may provide greater satiety after consumption. If desired, the fat content of the yogurt product may be controlled by selecting the fat content in the prefermentation ingredients or by supplementation. For example, a yogurt may be produced from full-fat milk and cream, or alternatively, from non-fat or low fat milk. Preferably, a fermented milk product will not be supplemented with a transfatty acid, which is desirable from the perspective of reducing “bad” cholesterol (LDL) levels in a subject.

On the other hand, beneficial fat content may be increased by supplementation with natural oils, fats or essential fatty acids. These include natural milk fats, omega-3 fatty acids, such as eicosapentaenoic acid, docosahexaenoic acid or alpha linolenic acid; or omega-6 fatty acids, such as linoleic acid or arachidonic acid. Omega-3 fatty acids are found in flaxseed oil, canola oil and walnut oil as well as from marine sources. Sources of Omega 6 oils include corn, sunflower seed, safflower, soy, sesame, and cottonseed oils. Suitable amounts of omega-3 (e.g., ALA, DHA, EPA) or omega-6 oils (e.g., linoleic acid, GLA) may be added, for example, from 0.1%, 0.2% 0.5%, 1%, 2%, 3.5%, 5% to 10% of the volume of the fermented dairy product.

The fermented milk product may contain particular ratios of omega-3 and omega-6 fats, for example, an omega-6 to omega-3 fat ratio of 0.25:1, 0.5:1, 1:1, 2:1, 3:1, 4:1, 5:1, or 10:1, or any intermediate ratio. It has been suggested that traditional human diets have omega 6:omega 3 ratios of 1-2:1. Excess omega 6 (or diminished omega 3) consumption have been associated with various disorders such as increases in cardiovascular, inflammatory or allergic disorders and decreases in immune and mental function.

Conjugated linoleic acids (CLA) are found in dairy products and are especially high (e.g., 3-5 times higher) in meat and milk obtain from grass-fed cattle as compared to grain-fed cattle. Consumption of CLA has been associated with increased fat loss, decreased insulin resistance, improved immune function and inhibition of cancer. The level of conjugated linoleic acids (CLA), which are naturally found in dairy products, may be supplemented by formulating the fermented dairy product from milk having high (e.g. 4-30 mg CLA/fat gram) CLA milk, or by adding CLA in an amount ranging from 2-60 mg CLA/gram of total fat. Alternatively, CLA may be added in unit amounts, such as 1, 5, 10, 20, 50, 100, 500 mg/8 oz serving of dairy product including any intermediate value within this range

Fat soluble vitamins (DRI), such as Vitamins A (900 μg/3000 IU), D (15 g/600 IU), E (15 mg) and K (120 μg) may also be added to the fermented dairy product in suitable amounts, for example, in fractional amounts of the DRI (daily recommended intake), e.g., 1%, 2%, 5%, 10%, 25%, 50%.

Mineral content, such as potassium, sodium or calcium content may be supplemented. For example, calcium content may be adjusted by adding calcium salts such as a calcium phosphate, calcium acid pyrophosphate, calcium carbonate, calcium chloride, calcium citrate, calcium gluconate, calcium glycerophosphate, calcium lactate, calcium lactobionate, calcium oxide, calcium phosphate monobasic, calcium phosphate dibasic, calcium phosphate tribasic, calcium stearate, or calcium sulfate to provide a calcium content ranging from 0.1% to 2.0% or any intermediate value or subrange thereof.

Other vitamins or antioxidants may also be added to increase nutritional value. For example, B vitamins, beta-carotene, Vitamin C or Vitamin E may be added. The DHHS/USDA Dietary Guidelines for Americans 2005 encourages the consumption of nutrient rich foods, which provide adequate nutrition without the overconsumption of calories. The Guidelines recognize that adults may require additional calcium, potassium, magnesium, fiber and vitamins A (as carotenoids), C and E; that children and adolescents may benefit from consuming nutrient rich foods containing more calcium, potassium, magnesium and vitamin E; and that other specific groups may need to consume more foods containing iron, vitamin B12, folic acid, and vitamins E and D. These specific groups include people over 50 who may need to increase vitamin B12 intake, women who may need to increase iron consumption, women of childbearing age or pregnant women who may need to increase folic acid intake; and the elderly, those having poor calcium uptake or osteoporosis, or those who do not produce adequate vitamin D due to insufficient sunlight or UV exposure. Specific high-fiber formulations may be designed for each of these groups based on the DHHS/USDA recommendations.

### EXAMPLE 1

### High Fiber Yogurt

Skim milk and condensed milk are mixed and non-fat dry milk, starch and vitamin A and D premix is added to the milk mixture. Gelatin is added to the resulting mixture. The mixture is allowed to hydrate for a minimum of 30 mins with agitation and then pre-heated to about 140° F. and homogenized.

The homogenized milk mixture is heated to approximately 198° F. and held for about 6.5 mins to kill pathogenic microorganisms.

Subsequently the mixture is cooled to a temperature of about 104° F. and inoculated with about 0.01% of a mixture of Lactobacillus bulgaricus and Streptococcus thermophilus. The mixture is held with minimal agitation at 104° F. until curd formation occurs and a break pH of about 4.60 is reached. To inhibit further reduction in pH and bacterial growth, the mixture (yogurt-like product or white mass) is agitated and cooled to about 65° F., filtered through a ⅛ inch wire mesh to remove lumps, and the filtered white mass is held up to 10 hours at this temperature.

The cooled white mass and a Fibersol-2-containing strawberry preparation containing about 21% dietary fiber as well as fructose and sucralose as sweeteners is pumped in line static mixer (Admixer™) at a massic ration of about 90:10 to produce a fruit and yogurt composition having a pH of about 4.30 and a viscosity of about 1,200 mPa·s. This amount provides about 10% of the recommended daily value (DV) of fiber, or about 2.5-3.0 gr of fiber per 4 oz serving. The filled containers are shipped and refrigerated at a temperature of about 41° F. prior to sale.

### EXAMPLE 2

### High Fiber Yogurt with Visible Fiber Component

A fiber fortified yogurt is produced as described by Example 1, except that 1.0% wheat germ is incorporated into the fruit preparation prior to mixing with the yogurt white mass.

### EXAMPLE 3

### High-Fiber, Reduced Carbohydrate Yogurt

To a mixture of ultrafiltered milk, skim milk and cream, WPC and gelatin (dry) are added. The mixture is allowed to hydrate for about 30 mins and then is heated to about 140° F. and homogenized. The homogenized milk mixture is heated to approximately 198° F. and held for about 6.5 mins to kill pathogenic microorganisms.

Subsequently the mixture is cooled to a temperature of about 102° F. and inoculated with about 0.01% of a mixture of Lactobacillus bulgaricus and Streptococcus thermophilus. The mixture is held with minimal agitation at 102° F. until curd formation occurs and a break pH of about 4.60 is reached. To inhibit further reduction in pH and bacterial growth, the mixture (yogurt-like product or white mass) is agitated and cooled to about 68° F., filtered through a ⅛ inch wire mesh to remove lumps, and the filtered white mass or yogurt-like product is held up to 10 hours at this temperature.

The cooled yogurt-like product and a Fibersol-2-containing strawberry preparation having about 21% dietary fiber and containing fructose and sucralose in a massic ratio of approximately 90:10 is pumped in line static mixer (Admixer™) to produce a fruit composition having a pH of about 4.30 and a viscosity of about 1,200 mPa·s. The filled containers are shipped and refrigerated at a temperature of about 41° F. prior to sale.

### EXAMPLE 4

### High-Fiber Non-Fat Smoothie Product

Non-fat milk and dry non-fat milk powder and Vitamin A & D premix is mixed and allowed to hydrate for about 30 mins. This mixture is heated to about 140° F. and homogenized. The homogenized milk mixture is heated to approximately 198° F. and held for about 6.5 mins to kill pathogenic microorganisms.

Subsequently the mixture is cooled to a temperature of about 102° F. and inoculated with about 0.01% of a mixture of Lactobacillus bulgaricus and Streptococcus thermophilus, as well as about 0.0012% Lactobacillus acidophilus. The mixture is held with minimal agitation at 102° F. until curd formation occurs and a break pH of about 4.60 is reached. To inhibit further reduction in pH and bacterial growth, the mixture (yogurt or white mass) is agitated and cooled to about 41° F., filtered through a ⅛ inch wire mesh to remove lumps, and the filtered white mass or yogurt is held up to 15 hours at this temperature. The cooled yogurt, water and a Fibersol-2-containing strawberry preparation containing about 21% dietary fiber and fructose and sucralose in a massic ratio of approximately 65:25:10 is pumped in line static mixer (Admixer™) to produce a high-fiber fruit beverage composition having a pH of about 4.25 and a viscosity of about 120 mPa·s.

### MODIFICATIONS AND OTHER EMBODIMENTS

Various modifications and variations of the disclosed processes and products and as well as the concept of the invention will be apparent to those skilled in the art without departing from the scope and spirit of the invention. Although the invention has been described in connection with specific preferred embodiments, it should be understood that the invention as claimed is not intended to be limited to such specific embodiments. Various modifications of the described modes for carrying out the invention which are obvious to those skilled in the food sciences, nutritional, microbiological, chemical or related fields are intended to be within the scope of the following claims.

1. A process for supplementing a fermented dairy product with fiber, comprising
mixing a fermented dairy base with an amount of fiber suitable for producing a product having:
a viscosity ranging from 500-2,000 mPa·s,
a pH ranging from 4.0 to 4.5, and
a fiber content ranging from 1 to 5%.

2. The process of claim 1, wherein said fermented dairy product is yogurt.

3. The process of claim 1, wherein said fermented dairy product is a full fat, high fat or whole milk yogurt.

4. The process of claim 1, wherein said fermented dairy product is low-fat or non-fat yogurt.

5. The process of claim 1, wherein said fermented dairy product is a low carbohydrate or reduced lactose yogurt-like product.

6. The process of claim 1, wherein said fermented dairy product is a set or blended yogurt product.

7. The process of claim 1, wherein said fermented dairy product is a drinkable yogurt or a smoothie-style drink containing yogurt.

8. The process of claim 1, wherein said fermented dairy product has at least 2% fiber content.

9. The process of claim 1, wherein said fermented dairy product has at least 3% fiber content.

10. The process of claim 1, wherein said fiber is digestion-resistant maltodextrin.

11. The process of claim 1, wherein said fiber is inulin.

12. The process of claim 1, wherein said fiber is oligofructose.

13. The process of claim 1, wherein said fiber comprises digestion-resistant maltodextrin, inulin and/or oligofructose, and a visible fiber component.

14. The process of claim 13, wherein the visible fiber component is wheat or oat bran or germ, or flax seed.

15. The process of claim 13, wherein said visible fiber component is set at 0.1-10% of the total fiber content of the product as an indication of total fiber content.

16. The process of claim 1, wherein said fermented milk product is yogurt which comprises a fruit juice, fruit puree, or fruit pieces.

17. The process of claim 16, wherein said fruit juice, fruit puree, or fruit pieces are present in an amount ranging from 1-30% by weight.

18. The process of claim 1, wherein said fermented milk product is yogurt formulated with one or more ingredients selected from the group consisting of MPC, WPC, modified corn starch, gelatin, kosher gelatin, vitamin A, vitamin D, fructose syrup, high-fructose corn syrup, natural flavor, malic acid, sucralose, potassium sorbate, or red 40.

19. The process of claim 1, wherein said fermented milk product is produced from an ultrafiltered milk.

20. The process of claim 1, wherein said fermented milk product contains live Lactobacillus acidophilus or Lactobacillus bifidus, or both.

21. The process of claim 1, further comprising adding to said fermented milk product one or more sweeteners selected from the group consisting of sucrose and dextrose.

22. The process of claim 1, further comprising adding to said fermented milk product fructose.

23. The process of claim 1, further comprising adding to said fermented milk product sucralose.

24. The process of claim 1, further comprising adding to said fermented milk product tagatose.

25. The process of claim 1, further comprising adding to said fermented milk product one or more sweeteners selected from the group consisting of aspartame, saccharin, cyclamate, acetsufame K, alitame, glycyrrhizin, stevioside, and thaumatin.

26. The process of claim 1, further comprising adding to said fermented milk product one or more food additive(s).

27. The process of claim 1, further comprising adding to said fermented milk product one or more flavoring(s).

28. The process of claim 1, further comprising adding to said fermented milk product one or more vitamin(s) or mineral(s).

29. The process of claim 1, further comprising adding to said fermented milk product one or more food color(s).

30. The process of claim 1, wherein the viscosity ranges from 900-1,600 mPa·s.

31. The process of claim 1, wherein said viscosity ranges from 1,000 to 1,400 mPa·s.

32. The process of claim 1, wherein said pH ranges from 4.1 to 4.4.

33. The process of claim 1, wherein said pH ranges from 4.2 to 4.3.

34. The process of claim 1, wherein said product has a total solids content in the range of about 5 to 15% by weight.

35. The process of claim 1, wherein said product has a protein content in the range of 0.5% to 5% by weight.

36. The process of claim 1, wherein said product has a fruit preparation content ranging from 3% to 12% by weight.

37-47. (canceled)
